(19) United States
(12) Patent Application Publication
(10) Pub. No.: US 2010/0221148 A1
(43) Pub. Date: Sep. 2, 2010

(54) COMBUSTIBLE GAS SENSOR

(75) Inventors: Tsutomu Oie, Kyoto (JP); Kazutaka Okamoto, Kyoto (JP); Yoshiaki Nakata, Kyoto (JP); Yutaka Yamagishi, Kyoto (JP); Shuji Takamatsu, Kyoto (JP)

Correspondence Address: CANTOR COLBURN, LLP, 20 Church Street, 22nd Floor, Hartford, CT, 06103, US

(73) Assignee: HORIBA, LTD., Kyoto-shi, Kyoto (JP)

(21) Appl. No.: 12/593,389

(22) PCT Filed: Mar. 19, 2008
(86) PCT No.: PCT/JP2008/055056

§ 371 Date: Sep. 28, 2009

(30) Foreign Application Priority Data
Mar. 28, 2007 (JP) 2007-084354
Mar. 30, 2007 (JP) 2007-090981
Feb. 22, 2008 (JP) 2008-041725

(51) Int. Cl. G01N 31/12

(52) U.S. Cl. 422/95; 977/742

(57) ABSTRACT

The present invention provides a combustible gas sensor that can realize a considerable improvement in the measurement sensitivity and the measurement precision by increasing the contact area between the measurement object gas and the oxidation catalyst particles, increasing the amount of heat generation of oxidation reaction in accordance therewith, and improving the transference of the oxidation reaction heat, while reducing the scale of the whole.

In this invention, a temperature measurement element such as a thermopile obtained by joining different kinds of metals is formed on a top surface of a Si substrate; a porous catalyst layer made by allowing a porous material layer to carry oxidation catalyst particles such as Pt or a chain-form catalyst layer made by linking and bonding numerous oxidation catalyst particles in a chain form is provided on a heat-sensitive part of this temperature measurement element; and this porous catalyst layer or the chain-form catalyst layer is integrally bonded with the heat-sensitive part of this temperature measurement element.

### FIELD OF THE ART

The present invention relates to a combustible gas sensor that is represented by a hydrogen gas sensor used for measurement of concentration of the combustible gas, particularly a hydrogen gas, contained in a measurement object gas by measuring the amount of heat generation of the measurement object gas, in order to prevent hazards such as explosion of a combustible gas such as CO, HC, formaldehyde, or hydrogen from occurring in a petrochemical factory or the like, for example.

### BACKGROUND ART

As the combustible gas sensor of this kind, those having a structure in which an oxidation catalyst such as platinum is laminated via an insulating layer on a surface of a temperature measurement element such as a thermistor, a thermoelectric couple (thermocouple), or an aluminum temperature measurement resistor are generally used. A generally used gas sensor having such a lamination structure has a large heat capacity, and hence has a small heat quantity by the oxidation reaction heat of the combustible gas. Therefore, an output signal that is taken out as a change in the voltage, electric current, or electric resistance by the change in heat quantity is also small, thereby providing a disadvantage in that the measurement sensitivity of a combustible gas of low concentration is extremely low.

Also, conventionally, a contact combustion type gas sensor is often used in which a cold contact point part of a thermopile is exposed while forming (vapor-depositing) a coating film of alumina or the like containing an oxidation catalyst such as platinum or palladium via an insulating film on a hot contact point part of the thermopile; the hot contact point part is heated to raise the temperature thereof by combustion accompanying the contact of the combustible gas such as a hydrogen gas to the coating film containing the oxidation catalyst such as platinum, so as to generate a thermoelectromotive force between this hot contact point part and the cold contact point part that is in a low-temperature state; and the concentration of the combustible gas is measured by detecting this thermoelectromotive force (see, for example, Patent Document 1). The contact combustion type gas sensor eliminates the need for a compensation circuit or the like to an ambient temperature as compared with the generally used gas sensor of lamination structure described above, so that an improvement in the measurement sensitivity can be achieved to some extent. However, the heat capacity is still large and the responsiveness is poor, thereby raising a problem in that a satisfactory result cannot be obtained in the measurement sensitivity of the combustible gas of low concentration.

In order to solve the disadvantages and the problems of the generally used gas sensor of lamination structure such as described above and the contact combustion type gas sensor, the present inventors have already proposed a combustible gas sensor in which a temperature measurement element such as a thermopile is formed on an insulating film that is formed on a semiconductor substrate surface; the heat-sensitive part of this temperature measurement element is allowed to carry an oxidation catalyst such as platinum or ruthenium by directly forming a film thereof or by forming a film via an adhesive layer containing a metal material having good heat conductivity such as Cr or Ti; and a heater is provided in order to maintain this oxidation catalyst to be in an active state (see, for example, Patent Document 2).

Patent Document 1: Japanese Patent Application Laid-open No. 05-10901

Patent Document 2: Japanese Patent Application Laid-open No. 2006-71362

### DISCLOSURE OF THE INVENTION

### Problems to be Solved by the Invention

The combustible gas sensor disclosed in the above Patent Document 2 can reduce the heat capacity of the temperature measurement element by adoption of a thin film forming technique such as formation of an insulating film, a temperature measurement element, and an oxidation catalyst onto a semiconductor substrate surface, and can measure the concentration of a predetermined combustible gas such as hydrogen by sensing the amount of oxidation reaction heat that is generated by contact of the combustible gas contained in the measurement object gas to the oxidation catalyst, so that it can achieve an improvement in the measurement sensitivity and the responsiveness as compared with the generally used gas sensor and the contact combustion type gas sensor described above. However, the oxidation reaction heat generated on the surface of the oxidation catalyst and the heat transference (speed, efficiency) at which the reaction heat is transferred to the heat-sensitive part of the temperature measurement element are not sufficient, thereby still leaving room for an improvement in terms of the measurement sensitivity and the measurement precision.

Also, the contact area of the measurement object gas to the oxidation catalyst cannot be made so large, so that the heat quantity generated by the oxidation reaction is small, and there is a limit to the improvement in the measurement sensitivity particularly of a combustible gas of low concentration. Also, in order to compensate for such a problem, it will be essential and necessary to provide a heater for maintaining the oxidation catalyst to be in an active state at all times, thereby raising a problem in that the gas sensor as a whole tends to be large.

Further, the combustible gas sensor of this kind is a so-called temperature sensor that takes out a change in the temperature of the heat-sensitive part as a change in voltage. Therefore, when the ambient measurement environment temperature changes, a drift (offset voltage) is generated in accordance with the temperature change of the heat-sensitive part irrespective of the action or the like of the measurement object gas, and this is output as if the amount of heat generation of the gas were measured. As a result thereof, the measurement value greatly fluctuates by receiving influences of the ambient temperature, thereby raising a problem in that a measurement error is generated. In order to solve such a problem, various devisings can be possibly performed for canceling or correcting the influence of the ambient temperature by providing a thermistor for measuring the ambient temperature separately from the temperature measurement element, providing a thermistor bridge in a temperature adjustment block, or using a thermopile array having a diaphragm structure. However, by any of these, the peripheral construction including the circuit is complex and is expensive in terms of costs, and the sensor as a whole tends to be large. Further, it is inevitable that variations in the characteristics are generated between the construction such as a thermistor for canceling or correcting the influence of the ambient temperature and the temperature measurement element. As a result thereof, there has been a problem in that there is inherently a limit to the improvement in the measurement precision.

The present invention has been made in view of the aforementioned circumstances, and a principal object thereof is to provide a combustible gas sensor that can increase the amount of heat generation of oxidation reaction by increasing the contact area between the measurement object gas and the oxidation catalyst while reducing the scale of the whole and achieving a lower cost, and can realize a considerable improvement in the measurement sensitivity and the measurement precision of even a combustible gas of low concentration by improving the heat transference to the temperature measurement element. In addition to the above principal object, another object thereof is to realize a further improvement in the measurement precision by eliminating the generation of drift irrespective of the change in the ambient temperature.

### Means for Solving the Problems

A combustible gas sensor according to the invention recited in claim 1 devised in order to achieve the aforementioned principal object is a combustible gas sensor constructed in such a manner that a temperature measurement element is formed on an insulating film that is formed on a semiconductor substrate surface, and the concentration of a combustible gas contained in a measurement object gas is measured by sensing the amount of heat generation of the measurement object gas with this temperature measurement element, characterized in that a porous catalyst layer made by allowing a porous material to carry oxidation catalyst particles or a chain-form catalyst layer made by linking and bonding numerous oxidation catalyst particles in a chain form is provided on a heat-sensitive part of the temperature measurement element, and the porous catalyst layer or the chain-form catalyst layer is integrally bonded with the heat-sensitive part.

### EFFECTS OF THE INVENTION

With the combustible gas sensor according to the invention recited in claim 1 having a characteristic construction such as described above, when the measurement object gas is brought into contact with the porous catalyst layer or the chain-form catalyst layer, the combustible gas contained in the measurement object gas generates a reaction heat by being oxidized with the oxidation catalyst particles carried on the porous catalyst layer or the chain-form oxidation catalyst particles forming the chain-form catalyst layer. For example, when the combustible gas is a hydrogen gas (H₂), as shown by the reaction formula:

2H₂+O₂→2H₂O+Q (1),

the hydrogen gas (H₂) molecules react with the oxygen gas (O₂) molecules to generate water molecules (H₂O) and, at this time, a reaction heat Q is generated. This reaction heat is efficiently transferred to the heat-sensitive part of the temperature measurement element by passing from the surface of the oxidation catalyst particles through the porous layer or directly from the surface of the chain-form oxidation catalyst layer particles, whereby the heat-sensitive part will have a raised temperature. Here, because the oxidation catalyst particles are carried on the porous layer or the oxidation catalyst particles are linked and bonded in a chain form, a sufficiently large contact area between the combustible gas contained in the measurement object gas and the oxidation catalyst particles can be attained, so that the amount of heat generation Q by the above reaction formula (1) is extremely large, and the degree of temperature rise of the heat-sensitive part of the temperature measurement element can be enhanced. Therefore, by using a porous catalyst layer carrying oxidation catalyst particles or a chain-form catalyst layer having oxidation catalyst particles linked and bonded in a chain form, the efficiency of temperature rise at the heat-sensitive part of the temperature measurement element can be enhanced while reducing the scale of the gas sensor as a whole. This produces an effect such that a considerable improvement in the concentration measurement sensitivity and measurement precision can be realized even with a combustible gas of low concentration such as hydrogen contained in the measurement object gas.

The porous catalyst layer in the combustible gas sensor according to the invention of claim 1 may be one formed by allowing a porous material selected from layer-form fibers, porous ceramics, and fibrous or cluster-form carbon nanotubes to carry oxidation catalyst particles selected from noble metals including platinum, palladium, rhodium, iridium, nickel, and ruthenium (claim 2). In particular, in the case of using, as the porous catalyst layer, those formed by bonding oxidation catalyst particles with a cluster-form carbon nanotube formed by growing on a plurality of nuclei that are agglomerated by heat treatment of a nickel thin film layer, an iron thin film layer, or a cobalt thin film layer (claim 3), the contact area with the measurement object gas can be ensured to be large; the bonding strength of the porous catalyst layer to the heat-sensitive part of the temperature measurement element can be enhanced to be tough; and the heat transference (speed, efficiency) of the oxidation reaction heat to the heat-sensitive part will be excellent, thereby achieving a further improvement in the measurement sensitivity.

Also, as the chain-form catalyst layer in the combustible gas sensor according to the invention of claim 1, those that are formed to have a porous form by linking and bonding oxidation catalyst particles with each other in a chain form by dispersing numerous oxidation catalyst particles with use of a dispersing agent and performing a heat treatment can be used (claim 4). In this case, the measurement object gas can be directly brought into contact with the chain-form oxidation catalyst particles, whereby the oxidation reaction heat quantity can be increased and the predetermined measurement sensitivity and measurement precision can be further improved.

Also, as the temperature measurement element in the combustible gas sensor according to the invention of claim 1, use of a thermopile is preferable (claim 5). Further, in the combustible gas sensor according to the invention of either of claims 1 through 5, the porous catalyst layer carrying the oxidation catalyst particles or the chain-form catalyst layer may be formed on a back surface of the heat-sensitive part of the temperature measurement element (claim 6). In this case, even if there is some position shift in forming the porous catalyst layer or the chain-form catalyst layer on the heat-sensitive part of the temperature measurement element, the catalyst layer is not brought into contact with the cold contact point part of the temperature measurement element in structure, and there is no sensitivity decrease accompanying the unnecessary temperature rise of the cold contact point part. As a result thereof, an improvement in the measurement sensitivity and the measurement precision can be achieved, and an effect of facilitating the mass production of combustible gas sensors having uniform characteristics is provided.

On the other hand, a combustible gas sensor according to the invention recited in claim 7 devised in order to achieve the aforementioned other object is a combustible gas sensor constructed in such a manner that the concentration of a combustible gas contained in a measurement object gas is measured by sensing the amount of heat generation of the measurement object gas with a temperature measurement element that is mounted on a semiconductor substrate surface, characterized in that at least two temperature measurement elements are mounted to be close to each other on the semiconductor substrate surface, and the temperature measurement elements are divided into those in which a porous catalyst layer made by allowing a porous material to carry oxidation catalyst particles that generate oxidation reaction heat by contact with the measurement object gas or a chain-form catalyst layer made by linking and bonding numerous oxidation catalyst particles in a chain form is provided on a heat-sensitive part and those in which the porous catalyst layer or the chain-form catalyst layer is not provided on the heat-sensitive part.

Also, a combustible gas sensor according to the invention recited in claim 8 devised in order to achieve the same object as the invention recited in claim 7 is a combustible gas sensor constructed in such a manner that the concentration of a combustible gas contained in a measurement object gas is measured by sensing the amount of heat generation of the measurement object gas with a temperature measurement element that is mounted on a semiconductor substrate surface, characterized in that one temperature measurement element having at least two heat-sensitive parts is mounted on the semiconductor substrate surface, and the heat-sensitive parts in the temperature measurement element are divided into those in which a porous catalyst layer made by allowing a porous material to carry oxidation catalyst particles that generate oxidation reaction heat by contact with the measurement object gas or a chain-form catalyst layer made by linking and bonding numerous oxidation catalyst particles in a chain form is provided and those in which the porous catalyst layer or the chain-form catalyst layer is not provided.

With the combustible gas sensor according to the invention recited in claim 7 and the invention recited in claim 8 having a characteristic construction such as described above, when the measurement object gas is brought into contact with the heat-sensitive part of the temperature measurement element on the side in which the porous catalyst layer or the chain-form catalyst layer is provided (hereinafter referred to as a temperature measurement element for measurement) and the heat-sensitive part side of the temperature measurement element on the side in which the porous catalyst layer or the chain-form catalyst layer is not provided (hereinafter referred to as a temperature measurement element for comparison), the combustible gas contained in the measurement object gas generates a reaction heat by being oxidized with the oxidation catalyst particles carried on the porous catalyst layer or the chain-form catalyst layer of the temperature measurement element for measurement. For example, when the combustible gas is a hydrogen gas (H₂), as shown by the reaction formula:

2H₂+O₂→2H₂O+Q (1),

the hydrogen gas (H₂) molecules react with the oxygen gas (O₂) molecules to generate water molecules (H₂O) and, at this time, a reaction heat Q is generated. By a large amount of heat including this reaction heat Q and the heat quantity contained in the measurement object gas that fluctuates in accordance with the change in the ambient temperature, the temperature of the heat-sensitive part of the temperature measurement element for measurement rises rapidly, and a voltage corresponding to the temperature is output. On the other hand, in the heat-sensitive part of the temperature measurement element for comparison, the reaction heat by the chemical reaction such as described above is not generated. Therefore, only by the heat quantity contained in the measurement object gas that fluctuates in accordance with the change in the ambient temperature, the temperature of the heat-sensitive part of the temperature measurement element for comparison rises, and a voltage corresponding to the temperature is output. By determining the difference between these two output voltages, the voltage caused by the reaction heat alone is obtained irrespective of the change in the ambient temperature. By determining the concentration of the combustible gas such as hydrogen contained in the measurement object gas from the voltage, the predetermined combustible gas concentration can be measured at high precision without being affected by the change in the ambient temperature.

Moreover, a peripheral construction having a complex circuit or the like such as those provided with a thermistor for measuring the ambient temperature, a thermistor bridge in the temperature adjustment block, or a thermopile array having a diaphragm structure separately from the temperature measurement element is not used. Instead, it is sufficient that at least two temperature measurement elements are mounted having the same construction except that they are divided into those provided with a porous catalyst layer or the chain-form catalyst layer on the heat-sensitive part and those not provided, or at least two heat-sensitive parts are formed in one temperature measurement element. Therefore, the production is easy, and the structure is simple, thereby facilitating the cost reduction and scale reduction of the gas sensor as a whole. Further, since the characteristics of the temperature measurement elements or the heat-sensitive parts can be uniformized, it produces such an effect that a gas sensor having high precision without being affected by the change in the ambient temperature can be obtained with ease and certainty.

The combustible gas sensor according to the invention recited in claim 7 or 8 can be constructed in such a manner that an operation amplifier is connected to each of the temperature measurement element for measurement and the temperature measurement element for comparison, and the difference of the outputs of these operation amplifiers, namely the offset voltage, is canceled in an external circuit. In particular, in the case of adopting a construction such that the temperature measurement element for measurement and the temperature measurement element for comparison are connected so that the polarities of the two will be reverse to each other in series as recited in claim 9, the offset voltages can be canceled with each other by simple wiring connection using, for example, a bonding wire or the like. Therefore, there is no need for drawing the wiring to the outside and reversely connecting to the external circuit and no need for use of a differential amplifier, so that the drift can be prevented with a further simple construction, and an improvement in the measurement precision can be realized.

Also, in the combustible gas sensor according to the invention recited in claim 7 or 8, in the case of adopting a construction such that an operation amplifier is connected to each of the temperature measurement element for measurement and the temperature measurement element for comparison, and a differential circuit for operating the difference of the outputs of these operation amplifiers is mounted on the semiconductor substrate surface as recited in claim 10, the connection between each temperature measurement element and the operation amplifier can be carried out with an extremely short distance, and the whole sensor including the temperature measurement elements, the operation amplifiers, and the differential circuit can be covered with a shield case such as a metal cap, whereby a gas sensor being strong against the external turbulence such as an electromagnetic wave and being excellent in the handling property can be provided.

The porous catalyst layer in the combustible gas sensor according to the invention of claim 7 or 8 may be one formed by allowing a porous material selected from layer-form fibers, porous ceramics, and fibrous or cluster-form carbon nanotubes to carry oxidation catalyst particles selected from noble metals including platinum, palladium, rhodium, iridium, nickel, and ruthenium (claim 11). In particular, as the porous material, it is preferable to select a cluster-form carbon nanotube (including Carbon Nano Tube, hereinafter referred to as CNT). In this case, heat conductivity is extremely large (incidentally, the heat conductivity of CNT is about 6000 W/m·K), and the contact area to the combustible gas contained in the measurement object gas can be taken to be large, so that the reaction heat generated in the CNT can be increased; the heat-sensitive part can be allowed to rise rapidly and greatly by transferring the large reaction heat rapidly and efficiently to the heat-sensitive part of the temperature measurement element; and a voltage corresponding to the temperature can be output, whereby the predetermined combustible gas concentration can be measured at high precision without being affected by the change in the ambient temperature, and a considerable improvement in the measurement sensitivity can be achieved. Therefore, it can be effectively used also for measurement of a combustible gas of low concentration.

In particular, in the case of using, as the porous catalyst layer in the combustible gas sensor according to the invention of claim 7 or 8, those formed by bonding oxidation catalyst particles with a cluster-form CNT formed by being grown on a plurality of nuclei that are agglomerated by heat treatment of a nickel thin film layer, an iron thin film layer, or a cobalt thin film layer (claim 12), the contact area with the measurement object gas can be ensured to be large; the bonding strength of the porous catalyst layer to the heat-sensitive part of the temperature measurement element can be enhanced to be tough; and the heat transference (speed, efficiency) of the oxidation reaction heat to the heat-sensitive part will be excellent, thereby achieving a further improvement in the measurement sensitivity.

Also, as the chain-form catalyst layer in the combustible gas sensor according to the invention of claim 7 or 8, those that are formed to have a porous form by linking and bonding oxidation catalyst particles with each other in a chain form by dispersing numerous oxidation catalyst particles with use of a dispersing agent and performing a heat treatment can be used (claim 13). In this case, the measurement object gas can be directly brought into contact with the chain-form oxidation catalyst particles, whereby the oxidation reaction heat quantity can be increased and the predetermined measurement sensitivity and measurement precision can be further improved.

Also, as the temperature measurement element in the combustible gas sensor according to the invention of claim 7 or 8, use of a thermopile is preferable (claim 14).

Further, in the event that, as the connection means between CNT and the heat-sensitive part of the temperature measurement element for measurement in the case of selecting a cluster-form CNT as a porous material that forms a porous catalyst layer in the combustible gas sensor according to the invention recited in claim 7 or 8, means for connection by bonding between a sulfur atom of a thiol group attached to one end of CNT and a metal atom of a metal film formed on an insulating film part on the heat-sensitive part of the temperature measurement element for measurement is adopted as recited in claim 15, the two (CNT and the temperature measurement element) can be connected without giving a thermal and mechanical stress and a damage by the stress to the thin insulating film on the heat-sensitive part of the temperature measurement element, whereby the combustible gas sensor can have a higher quality and higher performance.

Also, any of means for connecting the CNT and the heat-sensitive part of the temperature measurement element for measurement by a chemical bond between a terminal end of a functional group that modifies a part of a diamond thin film formed in the insulating film part on the heat-sensitive part of the temperature measurement element and a terminal end of a functional group that modifies one end of the carbon nanotube as recited in claim 16, and means for connecting the CNT and the heat-sensitive part of the temperature measurement element for measurement by direct chemical bond of a terminal end of CNT terminalized with a silane coupling agent to a thin insulating film part on the heat-sensitive part of the temperature measurement element as recited in claim 17 may be adopted. In these cases, a film formation structure by a chemical bond of terminal ends of functional groups with each other between the diamond thin film and the CNT or a self-organization molecule film structure by a direct chemical bond with use of a silane coupling agent is achieved, and the reaction heat and the heat contained in the measurement object gas can be transferred to each heat-sensitive part rapidly and without a loss, whereby a further improvement in the measurement sensitivity and the measurement precision can be achieved.

### BRIEF DESCRIPTION OF THE DRAWINGS

FIG. 1 is a longitudinal cross-sectional view of a combustible gas sensor of First Example according to the present invention.

FIG. 2 is an enlarged model view of a porous catalyst layer in the combustible gas sensor of First Example.

FIG. 3 is a longitudinal cross-sectional view of a combustible gas sensor of Second Example according to the present invention.

FIG. 4 is a longitudinal cross-sectional view of a combustible gas sensor of Third Example according to the present invention.

FIGS. 5(a) and 5(b) are both enlarged model views of a porous catalyst layer in the combustible gas sensor of Third Example.

FIG. 6 is a longitudinal cross-sectional view of a combustible gas sensor of Fourth Example according to the present invention.

FIG. 7 is an enlarged longitudinal cross-sectional view of a porous catalyst layer in the combustible gas sensor of Fifth Example according to the present invention.

FIG. 8 is a longitudinal cross-sectional view of a combustible gas sensor of Sixth Example according to the present invention.

FIG. 9 is a plan view showing a combustible gas sensor of Seventh Example according to the present invention in a state in which a part of the construction thereof has been removed.

FIG. 10 is a longitudinal cross-sectional view along the line X-X of FIG. 9.

FIG. 11 is a bottom view of an essential part of the combustible gas sensor of Seventh Example.

FIG. 12 is a plan view of an essential part of the combustible gas sensor of Seventh Example.

FIG. 13 is an equivalent circuit diagram of the combustible gas sensor of Seventh Example.

FIG. 14 is one example of a measurement circuit of the combustible gas sensor of Eighth Example according to the present invention.

FIG. 15 is an enlarged longitudinal cross-sectional view of an essential part of the combustible gas sensor of Ninth Example according to the present invention.

### DESCRIPTION OF THE SYMBOLS

1-1, 1-2, . . . , 1-9 combustible gas sensor
2 Si substrate (one example of semiconductor substrate)
4, 40A, 40B thermopile (one example of temperature measurement element)
4a, 4b, 40a, 40b hot contact point part (one example of heat-sensitive part)
5 insulating film
6 porous catalyst layer
6a porous material
6b Pt fine particles (one example of oxidation catalyst fine particles)
7 chain-form catalyst layer
8 porous layer
12, 12A, 12B CNT (one example of cluster-form carbon)
13 nickel thin film layer, iron thin film layer, or cobalt thin film layer
15A, 15B operation amplifier
19 Au thin film (one example of metal film)

### BEST MODES FOR CARRYING OUT THE INVENTION

Hereinafter, embodiments of the present invention will be described with reference to the drawings.

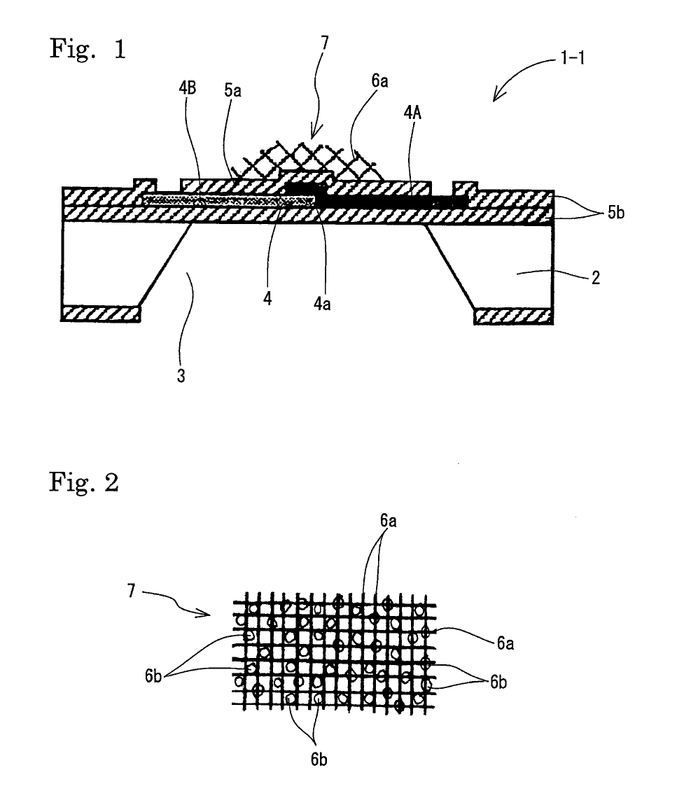

FIG. 1 is a longitudinal cross-sectional view of a combustible gas sensor of First Example according to the present invention. This combustible gas sensor 1-1 is constructed in such a manner that a hollow part 3 is formed by etching in a back surface of a central part of a silicon (Si) substrate (one example of semiconductor substrate) 2; a thermopile 4 made, for example, by joining different kinds of metals 4A, 4B such as polysilicon and aluminum and generating and outputting a thermoelectromotive force by the Seebeck effect according to the amount of received heat is formed on a top surface of the Si substrate 2 corresponding to this hollow part 3 as one example of a temperature measurement element; and insulating films 5a, 5b of SiO₂ or the like is formed on the front surface of this thermopile 4 and on the whole area of the top surface of the Si substrate 2 around the thermopile 4.

As illustrated in the enlarged model view of FIG. 2, on the insulating film 5a part made of SiO₂ on the hot contact point part 4a which is a heat-sensitive part of the thermopile 4, a porous catalyst layer 7 made by allowing a fibrous porous material 6a such as carbon fibers to carry dispersing platinum (Pt) particles 6b serving as one example of oxidation catalyst particles is provided, and this porous catalyst layer 7 is chemically or physically bonded to the insulating thin film 5a part on the hot contact point part 4a of the thermopile 4.

Here, as the oxidation catalyst particles in the porous catalyst layer 7, noble metal particles such as palladium (Pd), rhodium (Rh), iridium (Ir), nickel (Ni), or ruthenium (Ru) may be used either alone or as a combination besides the Pt particles 6b.

In the combustible gas sensor 1-1 of First Example constructed as shown above, when a measurement object gas containing a combustible gas such as hydrogen is brought into contact with and penetrates into the porous catalyst layer 7 carrying the Pt particles 6b, the combustible gas in the measurement object gas, for example, hydrogen gas (H₂) molecules are brought into contact with the Pt particles 6b carried on the porous catalyst layer 7, and generates water molecules (H₂O) by reacting with oxygen gas (O₂) molecules as shown by the already described formula (I). At this time, a reaction heat Q is generated.

Here, since the Pt particles 6b in the porous catalyst layer 7 are carried on the fibrous porous material 6a such as carbon fibers, the contact area between the combustible gas contained in the measurement object gas and the Pt particles 6b is large; the reaction heat Q will be extremely large; the large reaction heat is transferred rapidly and efficiently from the surface of the Pt particles 6b to the hot contact point part 4a of the thermopile 4 by passing though the fibrous porous material 6a such as carbon fibers having large heat conductivity, whereby the hot contact point part 4a will have a greatly raised temperature rapidly, and a large thermoelectromotive force is generated between the hot contact point part 4a and the cold contact point part. By measuring this thermoelectromotive force and calculating the heat quantity per unit period of time, the concentration of the combustible gas such as a hydrogen gas can be measured at extremely high sensitivity.

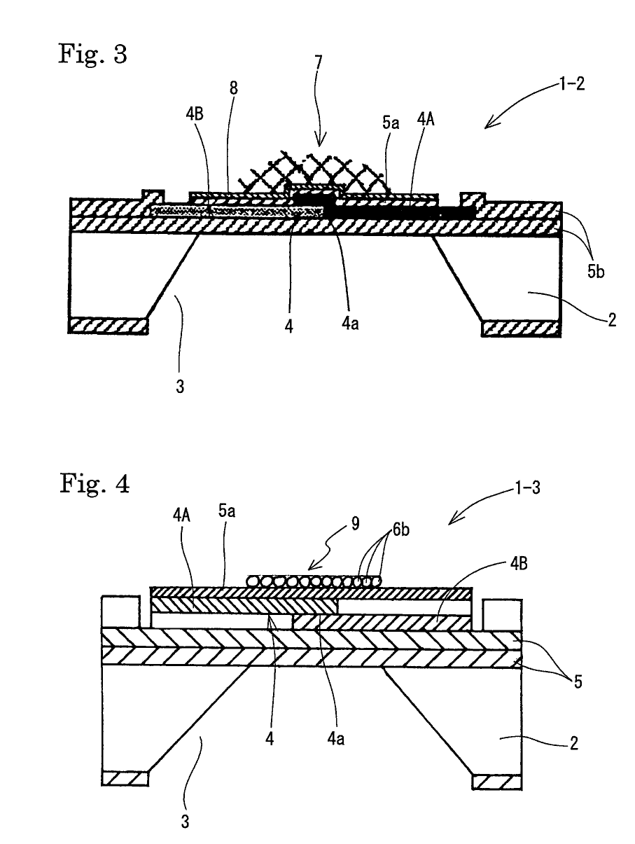

FIG. 3 is a longitudinal cross-sectional view of a combustible gas sensor of Second Example according to the present invention. This combustible gas sensor 1-2 of Second Example is constructed in such a manner that a porous layer 8 made of a material having high heat conductivity such as carbon fibers or porous ceramics is formed in a thin film form on the insulating film 5a part on the hot contact point part 4a of the thermopile 4, and a porous catalyst layer 7 similar to that of First Example is formed on this thin-film-form porous layer 8. The other constructions are the same as in the above-described First Example, so that the description thereof will be omitted by denoting identical members and identical sites with identical symbols.

In the combustible gas sensor 1-2 of Second Example also, in almost the same manner as in the combustible gas sensor 1-1 of First Example, when a measurement object gas is brought into contact with and penetrates into the porous catalyst layer 7, the combustible gas in the measurement object gas, for example, hydrogen gas (H₂) molecules are brought into contact with the Pt particles 6b carried on the porous catalyst layer 7, and generates water molecules (H₂O) by reacting with oxygen gas (O₂) molecules as shown by the already described formula (I). The reaction heat generated at this time is transferred efficiently from the surface of the Pt particles 6b to the hot contact point part 4a of the thermopile 4 by passing though the fibrous porous material 6a such as carbon fibers having large heat conductivity and the thin-film-form porous layer 8, whereby the hot contact point part 4a will have a greatly raised temperature rapidly, and a large thermoelectromotive force is generated between the hot contact point part 4a and the cold contact point part. By measuring this thermoelectromotive force and calculating the heat quantity per unit period of time, the concentration of the combustible gas such as a hydrogen gas can be measured at extremely high sensitivity.

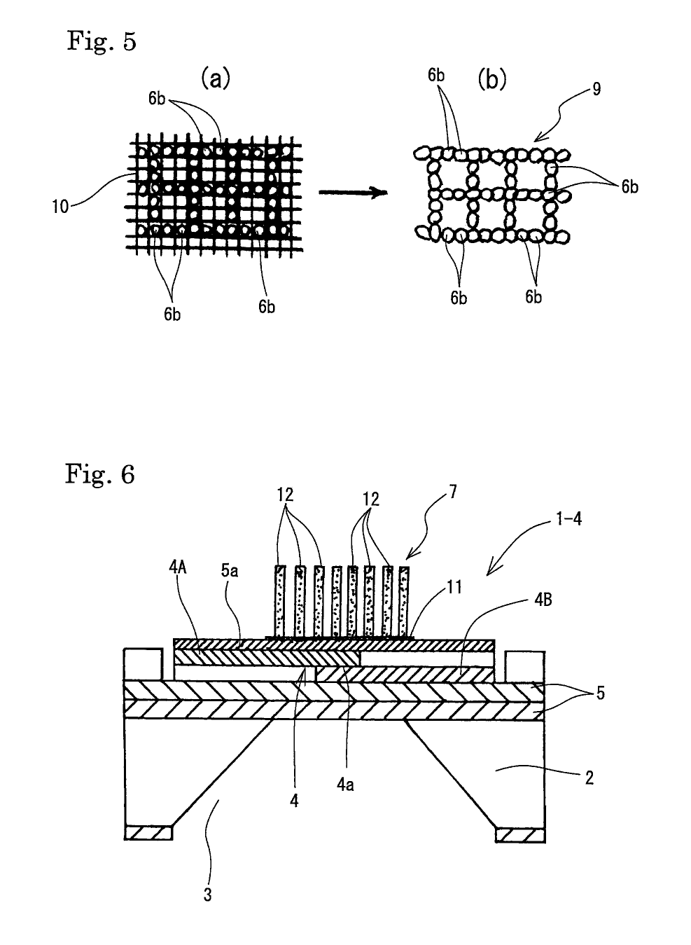

FIG. 4 is a longitudinal cross-sectional view of a combustible gas sensor of Third Example according to the present invention. This combustible gas sensor 1-3 of Third Example is constructed in such a manner that a double insulating film 5 made of SiO₂ and SiN is formed on a thermopile 4, and a chain-form catalyst layer 9 is formed on an insulating film part 5a corresponding to the hot contact point part 4a of the aforesaid thermopile 4. As illustrated in the enlarged model view of FIG. 5(a), this chain-form catalyst layer 9 is one example of oxidation catalyst particles and is formed to have a porous form by dispersing numerous Pt particles 6b having a comparatively large particle size into a material having a lower melting point than the Pt particles 6b, for example, a fiber material 10, with use of a dispersing agent and performing a heat treatment to allow the fiber material 10 having a low melting point to melt and disappear, whereby the remaining numerous Pt particles 6b will be linked and bonded with each other in a chain form and formed in porous state as illustrated in FIG. 5(b). The other constructions are the same as in the above-described First Example, so that the description thereof will be omitted by denoting identical members and identical sites with identical symbols.

In the combustible gas sensor 1-3 of Third Example, by being brought into direct contact with the chain-form Pt particles 6b that form the chain-form catalyst layer 9, a measurement object gas undergoes a reaction as shown by the already described formula (I) to generate a large reaction heat, and the reaction heat is efficiently transferred from the surface of the Pt particles 6b directly to the hot contact point part 4a of the thermopile 4, whereby the hot contact point part 4a will have a raised temperature, and a large thermoelectromotive force is generated between the hot contact point part 4a and the cold contact point part. By measuring this thermoelectromotive force and calculating the heat quantity per unit period of time, the concentration of the combustible gas such as a hydrogen gas can be measured at extremely high sensitivity.

FIG. 6 is a longitudinal cross-sectional view of a combustible gas sensor of Fourth Example according to the present invention. This combustible gas sensor 1-4 of Fourth Example is constructed in such a manner that a metal film, particularly a gold (Au) thin film 11, is formed on the insulating film 5a part on the hot contact point part 4a of a thermopile 4, and a plurality of carbon nanotubes (Carbon Nano Tube, hereinafter referred to as CNT) 12 are arranged on this Au thin film 11 as a representative example of the cluster-form carbon made by allowing the plane of the thin film 11 to carry Pt particles in advance, and these CNTs 12 are connected to the hot contact point part 4a of the thermopile 4 by forming a film having a CNT-R-S—Au structure obtained by bonding between a sulfur atom of a thiol group attached to one end thereof and an Au atom of the Au thin film 11, so as to form a porous catalyst layer 7. The other constructions are the same as in the above-described Third Example, so that the description thereof will be omitted by denoting identical members and identical sites with identical symbols.

As the connection means of the CNT 12, in addition to the connection made by bonding between a sulfur atom of a thiol group attached to one end and an Au atom of the Au thin film 11 as described above, connection can be made by forming a diamond thin film on the insulating film 5a part on the hot contact point part 4a of the thermopile 4, for example, by the CVD method, terminalizing one part of this diamond thin film with use of a functional group such as hydrogen, a hydroxyl group, a carboxyl group, or an amino group, terminalizing the carbon bond of the one part to one end of the CNT 12 with use of a functional group such as a carboxyl group or an amino group, and chemically bonding the terminals of the two functional groups with each other by dehydration polymerization. Alternatively, connection can be made by terminalizing one end of the CNT 12 with use of a silane coupling agent, and chemically bonding the terminal end directly to the insulating film 5a part of the hot contact point part 4a of the thermopile 4.

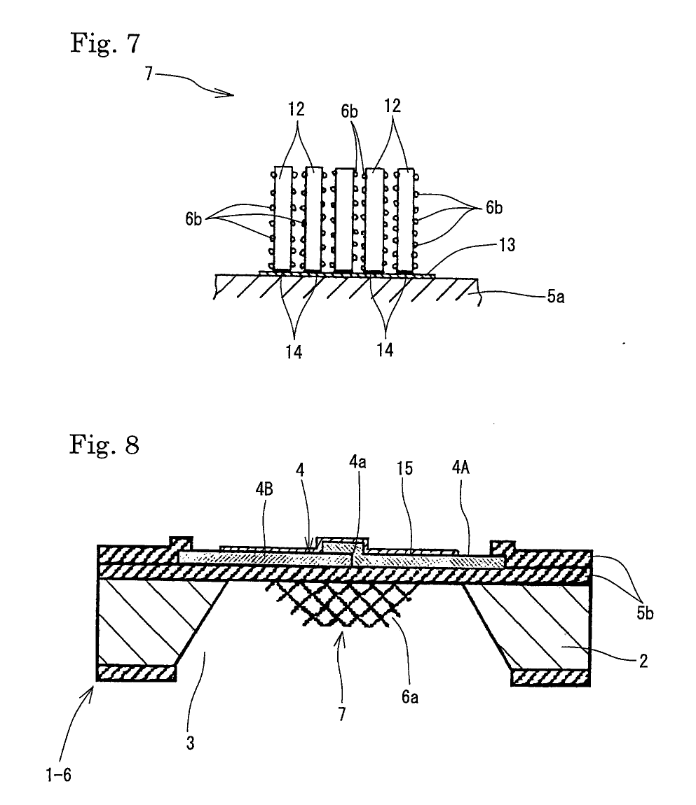

Further, as illustrated in FIG. 7, the combustible gas sensor of Fifth Example according to the present invention may be such that a cluster-form CNT 12 is formed by growing by the CVD method on a plurality of nuclei 14 that are agglomerated by a heat treatment of a nickel thin film layer, an iron thin film layer, or a cobalt thin film layer 13, and a porous catalyst layer 7 formed by attaching Pt particles 6b to this CNT 12 is chemically or physically bonded onto the insulating film 5a part of the hot contact point part 4a of the thermopile 4. The other constructions are the same as in the above-described Third Example, so that the construction of the gas sensor as a whole will be omitted.

In the case of these combustible gas sensors of Fourth Example and Fifth Example, by using the CNT 12 having extremely large heat conductivity and allowing a contact area with the measurement object gas to be taken large, a large thermoelectromotive force can be rapidly generated while reducing the scale of the gas sensor as a whole, whereby the concentration of the combustible gas such as a hydrogen gas can be measured at extremely high sensitivity and extremely high precision.

FIG. 8 is a longitudinal cross-sectional view of a combustible gas sensor of Sixth Example according to the present invention. This combustible gas sensor 1-6 of Sixth Example is constructed in such a manner that a porous catalyst layer 7 carrying Pt particles is formed at a part corresponding to the hot contact point part 4a on the back surface of the thermopile 4, and a protective film 15 is formed on the front surface of the thermopile 4. The other constructions are the same as in the above-described First Example, so that the description thereof will be omitted by denoting identical members and identical sites with identical symbols.

In the combustible gas sensor 1-6 of Sixth Example constructed in this manner, in the same manner as those shown in the above First to Fifth Examples, the concentration of the combustible gas such as a hydrogen gas can be measured at high sensitivity and high precision. In particular, when the porous catalyst layer 7 is formed on a back surface side of the thermopile 4, even if there is some position shift in the forming position in forming the porous catalyst layer 7 in correspondence with the hot contact point part 4a of the thermopile 4, the porous catalyst layer 7 is not brought into contact with the cold contact point part of the thermopile 4 in structure, and there is no sensitivity decrease accompanying the unnecessary temperature rise of the cold contact point part. As a result thereof, an improvement in the measurement sensitivity and the measurement precision can be achieved, and the mass production of combustible gas sensors having uniform characteristics is facilitated.

Here, in Sixth Example, the catalyst layer formed at a position corresponding to the hot contact point part 4a on the back surface of the thermopile 4 is not limited to the porous catalyst layer such as shown in FIG. 2, but may be a chain-form catalyst layer 9 made of Pt particles 6b bonded in a chain form such as shown in FIG. 5(b) or may be a porous catalyst layer 7 using the CNT 12 carrying the Pt particles as shown in FIG. 6 or 7.

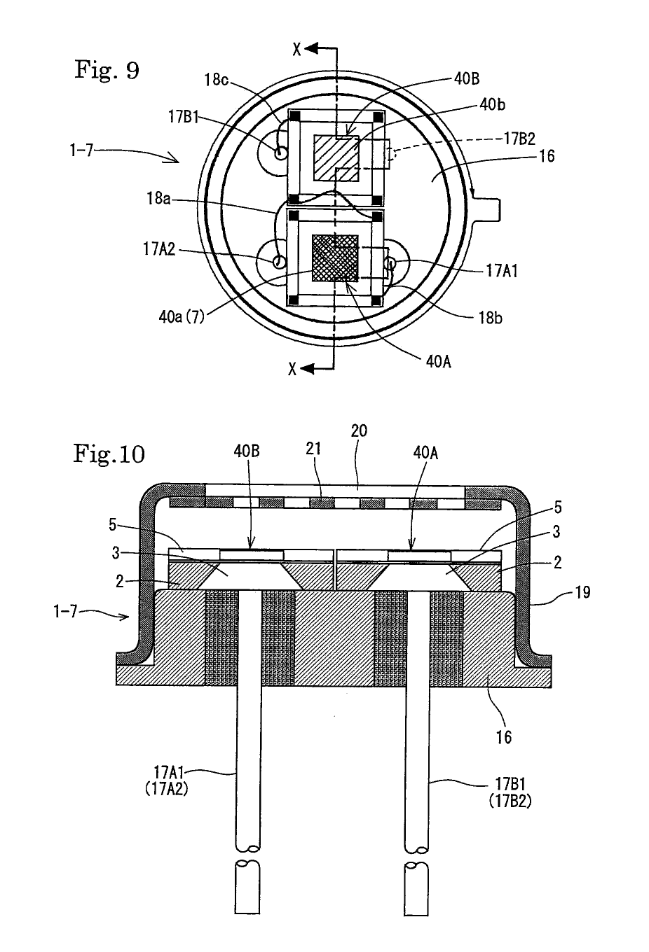

FIG. 9 is a plan view illustrating a combustible gas sensor of Seventh Example according to the present invention by removing one part of the construction thereof (the later-mentioned cap made of metal), and FIG. 10 is a longitudinal cross-sectional view along the line X-X of FIG. 9. This combustible gas sensor 1-7 of Seventh Example is constructed in such a manner that a hollow part 3 is formed by etching in a back surface of a central part of a silicon (Si) substrate (one example of semiconductor substrate) 2 that is provided by bonding on the whole surface of a stem 16; two thermopiles 40A, 40B made, for example, by joining different kinds of metals 4A, 4B (see FIG. 1) such as polycyan and aluminum and generating a thermoelectromotive force by the Seebeck effect according to the amount of received heat to output a voltage are formed to be close to each other on a top surface of the Si substrate 2 corresponding to this hollow part 3 as one example of a temperature measurement element; and a diaphragm-form insulating film 5 such as an SiO₂ thin film or an SiN thin film is formed on the whole area of the top surface of the Si substrate 2 including the front surfaces of these thermopiles 40A, 40B.

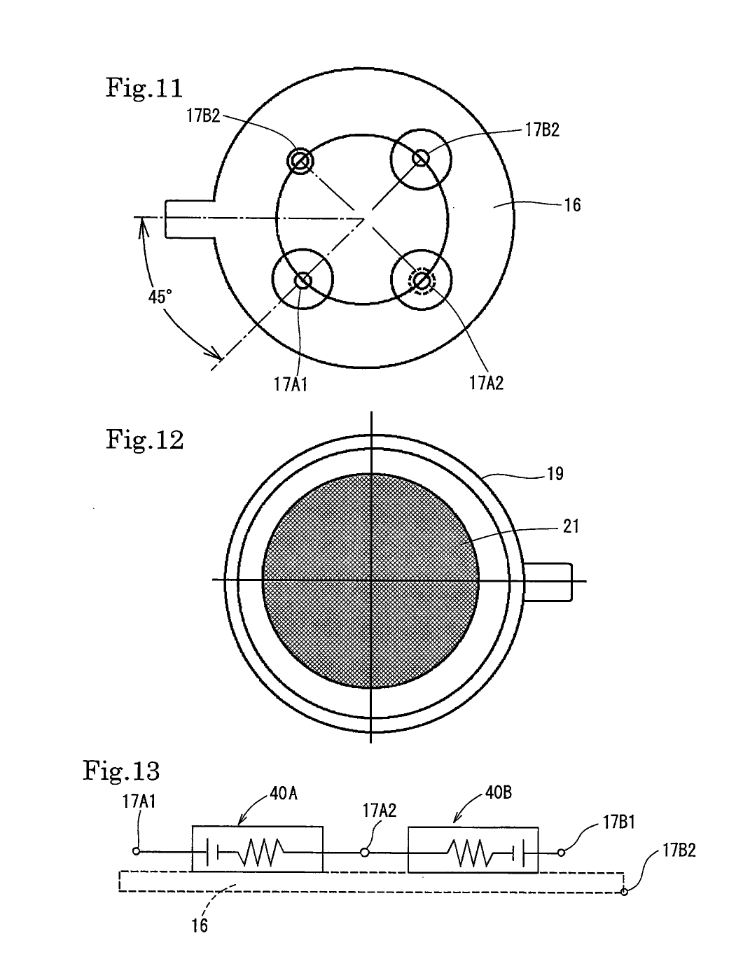

On the insulating film part on the hot contact point part 40a constituting the heat-sensitive part of one thermopile 40A among the thermopiles 40A, 40B, a porous catalyst layer 7 similar to those shown in FIGS. 1 and 2 is provided (hereinafter, this will be referred to as a thermopile for measurement). On the other hand, on the hot contact point part 40b of the other thermopile 40B, the porous catalyst layer is not provided (hereinafter, this will be referred to as a thermopile for comparison). In these two thermopiles 40A, 40B, respectively two terminals 17A1, 17A2, 17B1, 17B2 connected to the hot contact point parts 40a, 40b and the cold contact point part in a state of penetrating through the stem 16 are provided. These terminals 17A1, 17A2, 17B1, 17B2 are arranged at an equal interval of 90° in terms of the center angle on the same circumference as illustrated in FIG. 11.

Then, the negative output part (cold contact point part) of the thermopile 40A for measurement and the negative output part (cold contact point part) of the thermopile 40B for comparison are connected with each other by a bonding wire 18a and connected to the terminal 17A2 so that the polarities of the thermopile 40A for measurement and the thermopile 40B for comparison will be reverse to each other in series; the positive output part (hot contact point part 40a) of the thermopile 40A for measurement is connected by a bonding wire 18b to the terminal 17A1; and the positive output part (hot contact point part 40b) of the thermopile 40B for comparison is connected by a bonding wire 18c to the terminal 17B1, whereby an equivalent circuit such as shown in FIG. 13 is formed. Here, the terminal 17B2 is a case earth terminal.

Also, at the top part of the stem 16, a cap 19 made of a metal that surrounds and covers the two thermopiles 40A, 40B is fixed, for example, via means such as electric welding and, by this, the combustible gas sensor 1-7 is made into a package. An opening 20 is provided on the apex wall surface of the cap 19 made of a metal, and this opening 20 is closed by a metal mesh 21 that enables passage of the measurement object gas as illustrated in FIG. 12.

In the combustible gas sensor 1-7 of Seventh Example constructed as shown above, when the measurement object gas containing a combustible gas such as hydrogen is brought into contact with the Pt 6b carried by the porous catalyst layer 7 provided on the hot contact point part 4a of the thermopile 40A for measurement, the combustible gas, for example, the hydrogen gas (H₂) molecules, contained in the measurement object gas undergoes chemical reaction with the oxygen gas (O₂) molecules to generate water molecules (H₂O) as shown in the already described formula (1) and, at this time, a reaction heat Q is generated. By the reaction heat, the temperature of the hot contact point part 40a of the thermopile 40A for measurement rises, and an electromotive force corresponding to the temperature is generated to output a voltage. On the other hand, in the thermopile 40B for comparison, the reaction heat by the chemical reaction such as described above is not generated. Therefore, only by the heat quantity contained in the measurement object gas, the temperature of the hot contact point part 40b rises, and an electromotive force corresponding to the temperature is generated to output a voltage. By determining the difference between these two voltages, the voltage caused by the reaction heat alone is obtained. By determining the concentration of the combustible gas such as hydrogen contained in the measurement object gas from the voltage, the combustible gas concentration is measured.

When the ambient temperature changes at this measurement time, an offset voltage (drift) is transiently generated. The magnitude of the offset voltage is equivalent both in the thermopile 40A for measurement that carries Pt and in the thermopile 40B for comparison that does not carry Pt. Therefore, the predetermined combustible gas concentration measurement can be made at high precision irrespective of the change in the ambient temperature.

In particular, the combustible gas sensor 1-7 of Seventh Example is constructed in such a manner that the two thermopiles 40A, 40B are connected so that the polarities thereof will be reverse to each other in series, so that the offset voltages generated by the change in the ambient temperature can be canceled with each other. This eliminates the need for drawing a wiring to the outside and reversely connecting to an external circuit and can prevent the drift with a simple construction that does not need the use of a differential amplifier, thereby realizing an improvement in the measurement precision.

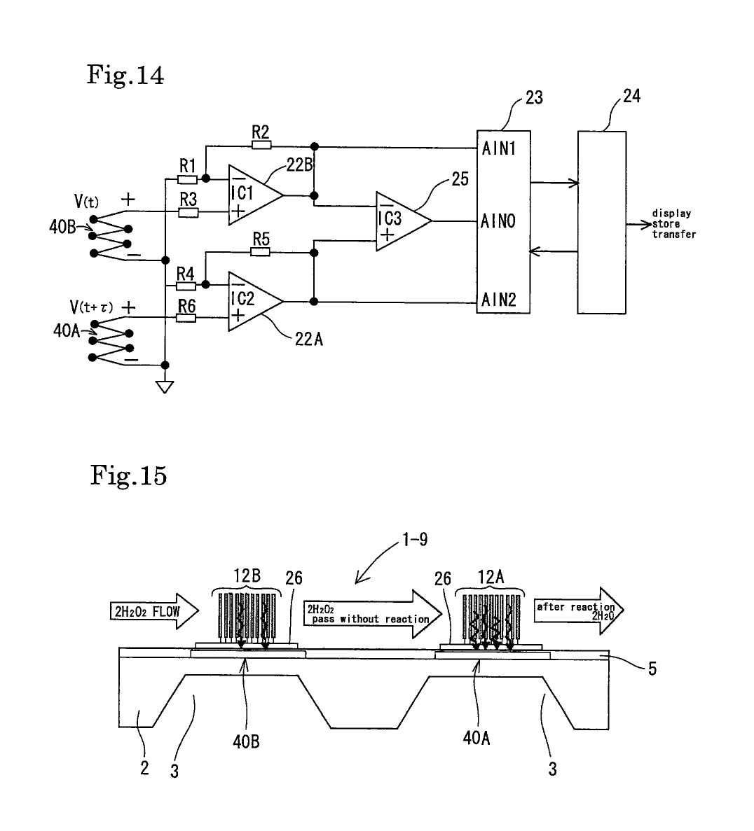

FIG. 14 is one example of a measurement circuit of a combustible gas sensor of Eighth Example according to the present invention. In this Eighth Example, instead of connecting the two thermopiles 40A, 40B so that the polarities thereof will be reverse to each other in reverse series, the later-mentioned measurement circuit is mounted in the inside of the package of the combustible gas sensor. The basic construction thereof is the same as the one described in the above-described Seventh Example, so that the illustration and the detailed description of the constructions will be omitted.

In the combustible gas sensor 1 of this Eighth Example, operation amplifiers 22A and 22B are connected that perform impedance conversion and voltage amplification of the electromotive forces that are respectively generated in the thermopile 40A for measurement and the thermopile 40B for comparison. This is because, since the electromotive force by a thermopile is small, each of the operation amplifiers 22A and 22B is allowed to have a gain so as to amplify until the voltage can be easily handled. Also, by setting the gain at this time to be R2/R1=R4/R3, the gains of the two operation amplifiers 22A, 22B are made equal.

Then, the two operation amplifiers 22A, 22B and a differential circuit that operates the difference of the outputs of these two operation amplifiers 22A, 22B are mounted on a Si substrate 2.

As the differential circuit, the digital signal obtained by directly inputting and performing an AD conversion of the outputs of the two operation amplifiers 22A, 22B into analog input terminals AIN1, AIN2 of an AD converter 23 may be taken into an MPU 24 to operate the difference of the two outputs (voltages) or, alternatively, the outputs of the two operation amplifiers 22A, 22B may be input into a differential amplifier 25 to determine the difference of the two outputs in advance, and the difference signal may be input into an analog input terminal AIN0 of the AD converter 23, and the digital signal subjected to the AD conversion may be taken into the MPU 24. In either case, by operating the temperature of the measurement object gas from the electromotive force generated by the thermopile 40B for comparison and correcting the temperature of the measurement object gas that has been operated from the electromotive force generated by the thermopile 40A for measurement with use of this operated temperature, the concentration of the combustible gas contained in the measurement object gas can be operated at high precision without being affected by the change in the ambient temperature.

Here, the concentration value of the combustible gas that is operated and output by the MPU 24 may be displayed as it is on a display section, or may be transferred, for example, by communication to an upper apparatus such as a host computer, or may be printed or stored and preserved in a memory.

As a material for forming the porous catalyst layer 7 that is provided on the heat-sensitive part 40a of the thermopile 40A for measurement in the above-described Seventh and Eighth Examples, layer-form fibers such as carbon fibers or porous ceramics can be used. As the oxidation catalyst particles in this porous catalyst layer 7, noble metal particles such as palladium (Pd), rhodium (Rh), iridium (Ir), nickel (Ni), or ruthenium (Ru) may be used either alone or as a combination besides the Pt particles 6b. Further, in place of the porous catalyst layer 7, a chain-form catalyst layer such as shown in FIGS. 4 and 5 may be provided.

Also, in the above-described Seventh and Eighth Examples, an example has been described in which two thermopiles 40A, 40B for measurement and comparison are formed to be close to each other on a Si substrate 2. However, instead of this, a construction may be made in which a single thermopile having two hot contact point parts is formed on a Si substrate 2; a porous catalyst layer or a chain-form catalyst layer is formed on one of the two hot contact point parts; and the porous catalyst layer or the chain-form catalyst layer is not provided on the other hot contact point part. With the construction such as this, a combustible gas sensor can be realized that produces the functions and effects similar to those of the combustible gas sensors of the above-described Seventh and Eighth Examples. Here, description and illustration of a concrete construction of the combustible gas sensor using this single thermopile will be omitted.

FIG. 15 is an enlarged longitudinal cross-sectional view of an essential part of the combustible gas sensor of Ninth Example according to the present invention. The combustible gas sensor 1-9 of this Ninth Example is constructed in such a manner that a metal film, particularly a gold (Au) thin film 26, is formed respectively on the insulating film 5 parts corresponding to the hot contact point parts (not illustrated) of the two thermopiles 40A, 40B that are formed to be close to each other on a Si substrate 2, and CNTs 12A, 12B are disposed on these Au thin films 26 and bonded and connected to the Au thin films 26.

Here, one CNT among the CNTs 12A, 12B corresponding to the two thermopiles 40A, 40B, namely the CNT 12A on the measurement thermopile 40A side, is a porous catalyst layer made by allowing CNT of a single layer or plural layers (multiple layers) to carry Pt 6b serving as one example of the oxidation catalyst particles in advance, and the other CNT 12B is such that the CNT of a single layer or plural layers is not allowed to carry Pt in the same manner as described above. Then, at one end of these CNT 12A carrying Pt and CNT 12B not carrying Pt, a thiol group is attached to one part, and a film of CNT-R-S—Au structure is formed by bonding between the sulfur atom S of this thiol group and the Au atom of the Au thin film 26 formed on the insulating film 5 parts on the two thermopiles 40A, 40B, whereby the CNT 12A carrying Pt and the CNT 12B not carrying Pt are bonded to the hot contact point parts of the thermopiles 40A, 40B.

Here, like the one in Seventh Example, the combustible gas sensor 1-9 of this Ninth Example may be one that has been made into a package with use of a stem 16 and a cap 19 made of a metal that is fixed so as to surround and cover the two thermopiles 40A, 40B at the top part thereof, or may be one that has not been made into a package by exposing the two CNTs 12A, 12B.

Also, as a measurement circuit of the combustible gas sensor 1-9 of this Ninth Example, the two thermopiles 40A, 40B that have been made into a package may be connected so that the polarities thereof will be in reverse series and reverse polarities, or a differential circuit such as shown in FIG. 14 may be used.

In the combustible gas sensor 1-9 of Ninth Example constructed as shown above, in the same manner as those shown in the above First to Seventh Examples, the concentration of the combustible gas such as a hydrogen gas can be measured at high sensitivity and at high precision. In particular, since the CNTs 12A, 12B having extremely large heat conductivity and enabling the contact area with the combustible gas contained in the measurement object gas to be taken large are connected to the hot contact point parts of the two thermopiles 40A, 40B, the reaction heat generated at the CNT 12A carrying Pt is extremely large; the reaction heat thereof can be rapidly and efficiently transferred to the hot contact point part of the thermopile 40A to allow the hot contact point part to rise rapidly and greatly; and the voltage corresponding to the temperature is output. In the CNT 12B not carrying Pt, only the heat quantity contained in the measurement object gas that fluctuates in accordance with the change in the ambient temperature is rapidly and efficiently transferred to the hot contact point part of the thermopile 40B to allow the hot contact point part to have a temperature reflecting the ambient temperature, and a voltage corresponding to the temperature is output. By determining the difference between these two output voltages, the voltage caused by the reaction heat alone is obtained irrespective of the change in the ambient temperature. By determining the concentration of the combustible gas such as hydrogen contained in the measurement object gas from the voltage, the predetermined combustible gas concentration can be measured at high precision without being affected by the change in the ambient temperature, and a considerable improvement in the measurement sensitivity can be achieved, so that it can be effectively used also for the measurement of a combustible gas of low concentration.

Here, although not illustrated in the drawings, a diamond thin film may be formed by the CVD method respectively on the insulating film 5 parts corresponding to the hot contact point parts of the two thermopiles 40A, 40B, or a diamond thin film made by depositing diamond particles with use of a silane coupling agent may be formed; one part of this diamond thin film may be terminalized with use of a functional group such as hydrogen, a hydroxyl group, a carboxyl group, or an amino group; the carbon bond of one part may be terminalized to one end of the two CNTs 12A, 12B with use of a functional group such as a carboxyl group or an amino group; and the terminals of the two functional groups may be chemically bonded with each other by dehydration polymerization, whereby the two CNTs 12A, 12B may be bonded and connected to the diamond thin film and the hot contact point part of each of the thermopiles 40A, 40B. In this case, a tough structure film can be formed at the bonding part of the diamond thin film and the two CNTs 12A, 12B.

Also, although not illustrated in the drawings, one part of the CNTs 12A, 12B may be terminalized with use of a silane coupling agent, and this terminal end may be connected by direct chemical bond to the insulating film 5 part on the hot contact point part of the thermopiles 40A, 40B.

Further, in each of the above-described examples, a heater or the like may be incorporated around the thermopile 4, 4A, or 4B, so as to heat the measurement object gas. In this case, by adjusting the heating temperature of the measurement object gas using the heater, combustible gases other than hydrogen contained in the measurement object gas can be measured, thereby giving selectivity to the measurement object gas.

Also, when the measurement object gas contains a plurality of combustible gases, the concentration of the combustible gases for each separated kind can be measured by separating the combustible gas kinds using a sampling apparatus and a column, and supplying oxygen to the combustible gases after separation so as to allow reaction on the thermopile 4, 4A, or 4B.

Further, in each of the above-described examples, description has been made on an example in which a thermopile is used as a temperature measurement element; however, in addition to that, those using a thermistor bolometer can produce an effect of improving the measurement sensitivity and measurement precision of a combustible gas while achieving the scale reduction of the sensor as a whole in the same manner as those described above.

### INDUSTRIAL APPLICABILITY

The combustible gas sensor according to the present invention can increase the amount of heat generation of oxidation reaction by increasing the contact area between the measurement object gas and the oxidation catalyst while reducing the scale of the whole, and can realize a considerable improvement in the measurement sensitivity and the measurement precision of even a combustible gas of low concentration by improving the heat transference to the temperature measurement element. Therefore, the combustible gas sensor can be effectively used for measurement of concentration of the combustible gas such as a hydrogen gas contained in a measurement object gas by measuring the amount of heat generation of the measurement object gas, in order to prevent hazards such as explosion of a combustible gas such as CO, HC, formaldehyde, or hydrogen from occurring in a petrochemical factory or the like, for example.

1. A combustible gas sensor for use with a measurement object gas comprising a combustible gas, the combustible gas sensor comprising:
a semiconductor substrate;
an insulating film provided on a surface of the semiconductor substrate;
a temperature measurement element provided on the insulating film; and
a porous catalyst layer, the porous catalyst layer comprising a porous material structured to carry oxidation catalyst particles, or a chain-form catalyst layer, the chain-form catalyst layer comprising a plurality of oxidation catalyst particles linked or bonded in a chain form, provided on a heat-sensitive part of the temperature measurement element;
wherein the temperature measurement element is structured to measure a concentration of the combustible gas contained in the measurement object gas by sensing an amount of heat generation of the measurement object gas with the temperature measurement element; and
the porous catalyst layer or the chain-form catalyst layer is integrally bonded with the heat-sensitive part.

2. The combustible gas sensor according to claim 1, wherein the porous catalyst layer is formed by allowing a porous material selected from layer-form fibers, porous ceramics, and fibrous or cluster-form carbon nanotubes to carry oxidation catalyst particles selected from noble metals including platinum, palladium, rhodium, iridium, nickel, and ruthenium.

3. The combustible gas sensor according to claim 1, wherein the porous catalyst layer is formed by bonding oxidation catalyst particles with a cluster-form carbon nanotube formed by growing on a plurality of nuclei that are agglomerated by heat treatment of a nickel thin film layer, an iron thin film layer, or a cobalt thin film layer.

4. The combustible gas sensor according to claim 1, wherein the chain-form catalyst layer is formed to have a porous form by linking and bonding oxidation catalyst particles with each other in a chain form by dispersing numerous oxidation catalyst particles with use of a dispersing agent and performing a heat treatment.

5. The combustible gas sensor according to claim 1, wherein the temperature measurement element comprises a thermopile.

6. The combustible gas sensor according to either claim 1, wherein the porous catalyst layer carrying the oxidation catalyst particles or the chain-form catalyst layer is formed on a back surface of the heat-sensitive part of the temperature measurement element.

7. A combustible gas sensor for use with a measurement object gas comprising a combustible gas, the combustible gas sensor comprising:
a semiconductor substrate;
a plurality of temperature measurement elements mounted on a surface of the semiconductor substrate;
wherein the temperature measurement element is structured to measure a concentration of the combustible gas contained in the measurement object gas by sensing an amount of heat generation of the measurement object gas with the temperature measurement element;
at least one of the plurality of temperature measurement elements comprises a porous catalyst layer, the porous catalyst layer comprising a porous material structured to carry oxidation catalyst particles, or a chain-form catalyst layer, the chain-form catalyst layer comprising a plurality of oxidation catalyst particles linked or bonded in a chain form; and
at least one of the plurality of temperature measurement elements does not include either of the porous catalyst layer or the chain-form catalyst layer.

8. A combustible gas sensor for use with a measurement object gas comprising a combustible gas, the combustible gas sensor comprising:
a semiconductor substrate;
a temperature measurement element mounted on a surface of the semiconductor substrate, the temperature measurement element comprising a plurality of heat-sensitive parts;
wherein the temperature measurement element is structured to measure a concentration of the combustible gas contained in the measurement object gas by sensing an amount of heat generation of the measurement object gas with the temperature measurement element;
at least one of the plurality of heat-sensitive parts comprises a porous catalyst layer, the porous catalyst layer comprising a porous material structured to carry oxidation catalyst particles, or a chain-form catalyst layer, the chain-form catalyst layer comprising a plurality of oxidation catalyst particles linked or bonded in a chain form; and
at least one of the plurality of heat-sensitive parts does not include either of the porous catalyst layer or the chain-form catalyst layer.

9. The combustible gas sensor according to claim 7, wherein the temperature measurement element on the heat-sensitive part side in which the porous catalyst layer or the chain-form catalyst layer is provided and the temperature measurement element on the side in which the porous catalyst layer or the chain-form catalyst layer is not provided are connected so that the polarities of the two will be reverse to each other in series.

10. The combustible gas sensor according to claim 7, wherein an operation amplifier is connected to each of the temperature measurement element on the heat-sensitive part side in which the porous catalyst layer or the chain-form catalyst layer is provided and the temperature measurement element on the side in which the porous catalyst layer or the chain-form catalyst layer is not provided, and a differential circuit for operating the difference of the outputs of these operation amplifiers is mounted on the semiconductor substrate surface.

11. The combustible gas sensor according to claim 7, wherein the porous catalyst layer is formed by allowing a porous material selected from layer-form fibers, porous ceramics, and fibrous or cluster-form carbon nanotubes to carry oxidation catalyst particles selected from noble metals including platinum, palladium, rhodium, iridium, nickel, and ruthenium.

12. The combustible gas sensor according to claim 7, wherein the porous catalyst layer is formed by bonding oxidation catalyst particles with a cluster-form carbon nanotube formed by growing on a plurality of nuclei that are agglomerated by heat treatment of a nickel thin film layer, an iron thin film layer, or a cobalt thin film layer.

13. The combustible gas sensor according to claim 7, wherein the chain-form catalyst layer is formed to have a porous form by linking and bonding oxidation catalyst particles with each other in a chain form by dispersing numerous oxidation catalyst particles with use of a dispersing agent and performing a heat treatment.

14. The combustible gas sensor according to claim 7, wherein a thermopile is used as the temperature measurement element.

15. The combustible gas sensor according to claim 7, wherein a cluster-form carbon nanotube selected as a porous material and the heat-sensitive part of the temperature measurement element are connected by bonding between a sulfur atom of a thiol group attached to one end of the carbon nanotube and a metal atom of a metal film formed on an insulating film part on the heat-sensitive part of the temperature measurement element.

16. The combustible gas sensor according to claim 7, wherein a cluster-form carbon nanotube selected as a porous material and the heat-sensitive part of the temperature measurement element are connected by a chemical bond between a terminal end of a functional group that modifies a part of a diamond thin film formed in the insulating film part on the heat-sensitive part of the temperature measurement element and a terminal end of a functional group that modifies one end of the carbon nanotube.

17. The combustible gas sensor according to claim 7, wherein a cluster-form carbon nanotube selected as a porous material and the heat-sensitive part of the temperature measurement element are connected by direct chemical bond of a terminal end of the carbon nanotube terminalized with a silane coupling agent to a thin insulating film part on the heat-sensitive part of the temperature measurement element.
